(19) United States
(12) Patent Application Publication
(10) Pub. No.: US 2012/0106141 A1
(43) Pub. Date: May 3, 2012

(54) GRAPHIC LIGHT MODULE FOR USE WITH PORTABLE DEVICE

(76) Inventor: Leslie Chan Dotson, Carson, CA (US)

(21) Appl. No.: 13/287,541

(22) Filed: Nov. 2, 2011

(30) Foreign Application Priority Data
Nov. 3, 2010 (TW) 099221256

(51) Int. Cl. F21L 4/08; F21L 4/00

(52) U.S. Cl. 362/183; 362/157

(57) ABSTRACT

A graphic light module for use with portable device includes a case body, a graphic light block, and a power supply unit. The case body is combined with the outer casing of the portable device and has an accommodating space. The graphic light block is replaceably disposed in the accommodating space. The graphic light block includes a light-permeable film, an image component combined with the light-permeable film, and a light emitting component. The power supply unit is disposed inside the case body and is electrically coupled to the light emitting component to allow the light emitting component to emit light in order to display a graphic image of the image component.

### BACKGROUND OF THE INVENTION

1. Field of the Invention

The present invention generally relates to a case for use with a portable device. Particularly, the present invention relates to a graphic light module to serve as a case module for portable devices.

2. Description of the Related Art

Cell phones and portable devices are personal use items and end users like to personalize them for fun and exciting usage, usually enjoyed both during the day and the night.

Lights or graphic image displays, especially flashing lights, can create an unique visual appearance. Cell phone and portable device industry strive to create new ways for end users and retailers to differentiate themselves from other end user and retailers.

On the other hand, cell phone displays are also frequently utilized by end users as a source of light in places of darkness. However, when searching for seats in a dark movie theater or if the cell phone or portable device falls under a seat of a car, the cell phone screen usually turns off quickly and the phone cannot then been seen. Thus, there exists a long-felt need for a source of light that end users may attach to their cell phones or portable devices to emit light and illuminate the area immediately around them.

Therefore, it is a motive of the inventor to create a graphic light module that can be integrated onto cell phones or portable devices without affecting the end users' ability to use all the available features of the cell phone or portable device. The graphic light module is not only able to emit light and illuminate the surrounding environment; it is also able to evoke the curiosity of surrounding people through personalization of the light emitting graphic image thereof.

### SUMMARY OF THE INVENTION

It is an object of the present invention to provide a graphic light module for use with a portable device to emit light or a graphic image in substantially all directions around the portable device.

The above object is achieved by providing a graphic light module for use with a portable device. The graphic light module includes a case body, a graphic light module, and a power supply unit. The case body is combined with the outer casing of the portable device and is formed with an accommodating space. A graphic light block is replaceably disposed in the accommodating space. The graphic light block includes a light-permeable film, an image component combined with the light-permeable film, and a light emitting component. The power supply unit is disposed in the case body and electrically coupled to the light emitting component, wherein the power supply unit supplies power to the light emitting component to allow the light emitting component to emit light to display a graphic image of the image component.

It is another object of the present invention to provide a graphic light module that may be easily integrated on portable devices. The case body of the graphic light module includes an attachment part, with which the graphic light module is secured onto the outer casing of the portable device without affecting the original appearance of the portable device.

It is a further object of the present invention to provide a graphic light module for portable devices, wherein the graphic light module utilizes the rechargeable battery or the solar cell to allow the graphic light module to be more environmentally friendly.

It is yet another object of the present invention to provide a graphic light module having a gouge disposed on the case body. A space exists between the graphic light block and the case body, allowing users insert the fingertip into the space to easily remove the graphic light block from the case body, such that personalization of the graphic light module may be achieved by replacing a customized or personalized light graphic block.

In comparison to the prior arts, the graphic light module of the present invention is combined on or integrated with the outer casing of the portable device without affecting the original appearance or usage of the portable device. In addition, the graphic light module can be independently operated in respect to the portable device or cell phone without affecting the current operation of the portable device or cell phone. Moreover, the graphic light block is replaceable, allowing users to personalize the graphic light module such that the graphic light module not only can be utilized as a flash light to illuminate surrounding areas, but can also present personal personality through personalized graphic image, triggering people's curiousness while increasing the convenience and practicality factor of the graphic light module thereof.

### BRIEF DESCRIPTION OF THE DRAWINGS

FIG. 1 is a three-dimensional view of the graphic light module for use with a portable device in accordance with an embodiment of the present invention;

FIG. 2 is an exploded view of the graphic light module for use with a portable device in accordance with an embodiment of the present invention;

FIG. 3 is a plan view of the graphic light module assembled with the portable device in accordance with an embodiment of the present invention;

FIG. 4 is a schematic view of assembling the graphic light module and the portable device in accordance with an embodiment of the present invention;

FIG. 5 is a schematic view showing the usage state of the graphic light module and the portable device in accordance with an embodiment of the present invention; and

FIG. 6 shows the graphic light module for use with a portable device in accordance with another embodiment of the present invention.

### DETAILED DESCRIPTION OF THE PREFERRED EMBODIMENT

The detailed description and technical content of the present invention are described below with reference to the drawings. However, it is clearly understood that the embodiments and drawings are only illustrative and not restrictive in any sense.

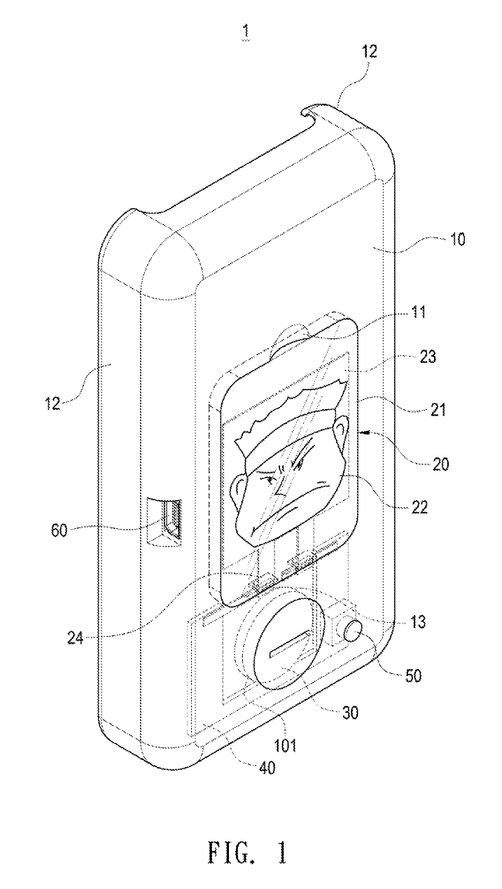

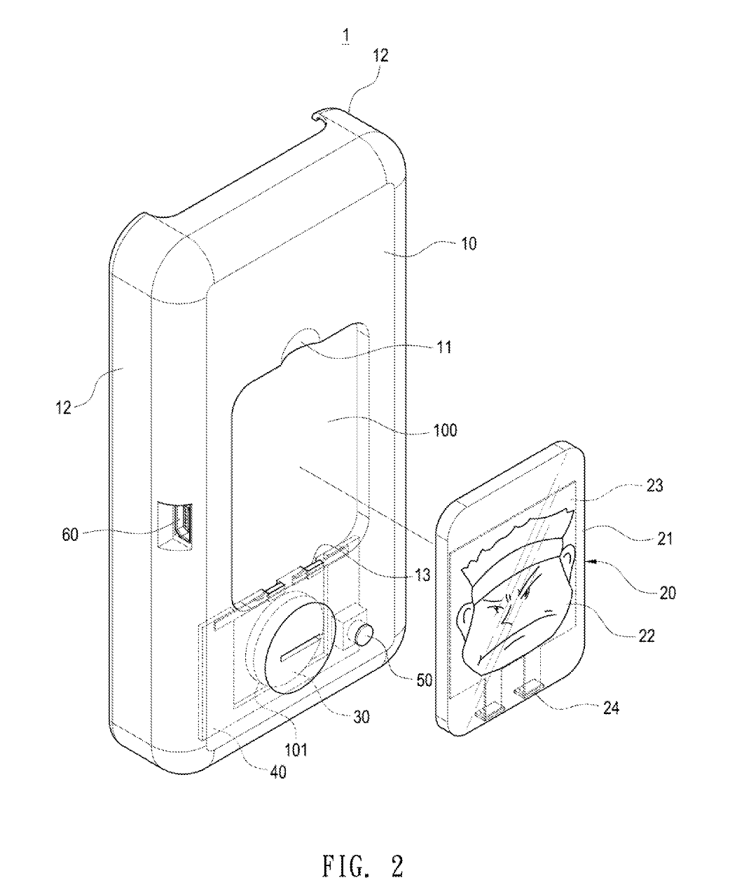

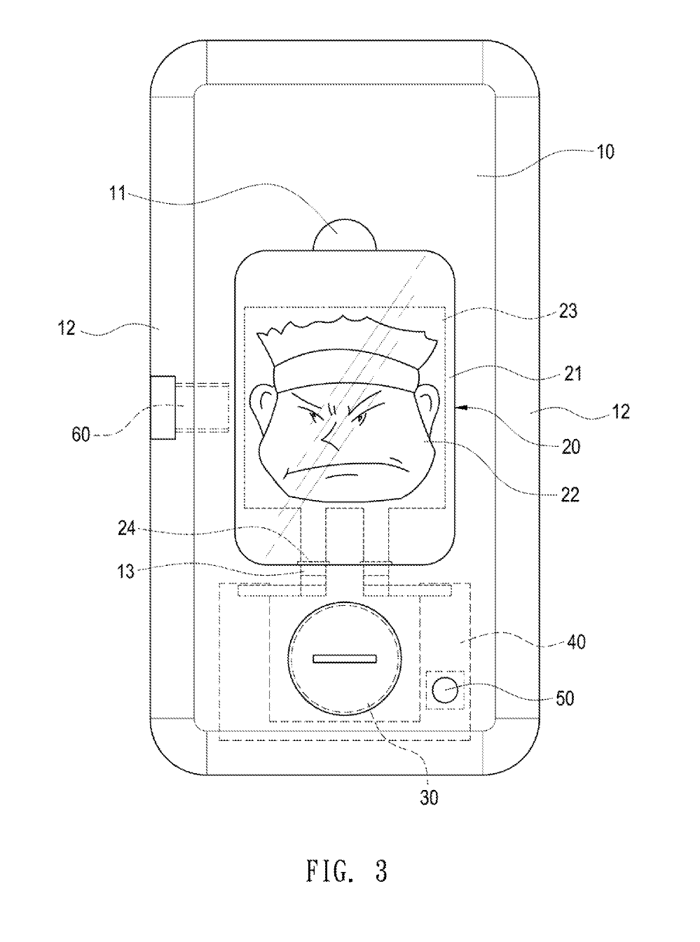

Referring to FIGS. 1 to 3, a three-dimensional view, an exploded view, and a schematic assembling view of a graphic light module for use with a portable device are provided in accordance with one embodiment of the present invention. In one embodiment, the graphic light module 1 can serve as a case module for portable devices, particularly portable electronic device including, but not limited to, cell phones or personal digital assistants. The graphic light module 1 includes a case body 10, a graphic light block 20, a power supply unit 30, a circuit board 40, and a switch device 50.

The case body 10 is formed with an accommodating space 100, wherein a gouge 11 is formed on one side of the accommodating space 100. In addition, the case body 10 has an attachment part 12. In the present embodiment, the attachment part 12 is disposed as an attachment prong of a sliding cover. Preferably, the case body 10 is a molded plate formed from transparent or clear materials such as Acrylic. The hardness of the material may be the same as the outer casing of the portable device. Additionally, the case body 10 may also have a coating, wherein the material of the coating can be translucent or painted.

The graphic light block 20 is replaceably disposed in the accommodating space 100, wherein the graphic light block 20 includes a light-permeable film 21, an image component 22 combined with the light-permeable film 21, and a light emitting component 23. The light-permeable film 21 has light-permeable/transparent properties, wherein the light-permeable film 21 may be formed from a transparent material. The image component 22 may be formed directly on the light-permeable film 21 from forming processes (such as in-mold decoration processes). Alternatively, the image component 22 may be disposed as a graphic image sheet or paper having a graphic image. The light emitting component 23 is utilized to generate enough light to illuminate objects in the immediate vicinity. The light emitting component 23 may be composed of a plurality of light emitting diodes (LEDs) or any suitable light sources such as electroluminescent lights (ELs). Furthermore, the light emitting component 23 may also be a liquid crystal display (LCD) or any such related lighting device to create ever more different vibrant colors, shapes, and light intensities. In the present embodiment, the image component 22 is a graphic image sheet/paper, while the light emitting component 23 is an electroluminescent light. When electric current passes through the electroluminescent light, the electroluminescent light produces light which passes through the image paper, creating the light transmission effect.

The power supply unit 30 is electrically coupled to the light emitting component 23, supplying electricity to the light emitting component 23 such that the light emitting component 23 produces light. In turn, the light illuminates the image component 23 such that the image of the image component 23 is displayed. The power supply unit 30 is disposed inside the case body 10. In the present embodiment, the case body 10 has a power source accommodating space 101, wherein the power supply unit 30 is disposed therein. The power supply unit 30 may be a one-time use battery, a rechargeable battery, or a solar cell. The circuit board 40 and the switch device 50 electrically coupled to the circuit board 40 may be installed in the case body 10, wherein the circuit board 40 is also electrically coupled to the light emitting component 23 and the switch device 50 controls the activation of the light emitting component 23 through the circuit board 40.

The switch device 50 may be an on-off switch or a multi-way switch. In the instance that the switch device 50 is an on-off switch, the switch device 50 is used for turning on or off the light emitting component 23. In the instance that the switch device 50 is a multi-way switch, the switch device 50 can cause the circuit board 40 to perform different functions depending on the position of the switch. For instance, the switch may control the on/off status, the flashing frequency, or any other status of the light emitting component 23.

The switch device 50 may also be coupled to a light or motion sensor such that if the ambient light is detected to be under a certain threshold or if an object movement is detected, a signal will be transmitted to the circuit board 40. The circuit board 40 may then instruct the power supply unit 30 to provide electricity to the light emitting component 23 to allow the light emitting component 23 to produce light.

In the instance that the power supply unit 30 is a rechargeable battery, a charging port 60 may be installed on the case body 10. The charging port 60 is electrically coupled to the circuit board 40, allowing the external power source to recharge the power supply unit 30 through the charging port 60. In effect, the power supply unit 30 may be repeatedly used by recharging through the charging port 60.

The case body 10 has a first contact point 13 disposed near one side of the circuit board 40 within the accommodating space 100, wherein the first contact point 13 is electrically coupled to the circuit board 40. Correspondingly, a second contact point 24 is disposed on one side of the light-permeable film 21 of the graphic light block 20 adjacent to the circuit board 40, wherein the second contact point 24 is electrically coupled to the light emitting component 23. In this manner, the first contact point 13 and the second contact point 24 will be in contact with each other when the graphic light block 20 is disposed in the accommodating space 100. As such, the circuit board 40 is electrically coupled to the power supply unit 30, allowing the power supply unit 30 to supply electricity to the light emitting component 23 through the circuit board 40.

After the graphic light block 20 is secured in the accommodating space 100, there exists a space between the gouge 11 of the case body 10 and the light-permeable film 21 to allow easy removal of the graphic light block 20. Users need only insert their fingertip into the space to unseat the graphic light block 20 from the accommodating space 100. In this manner, the graphic light block 20 may be easily removed and replaced.

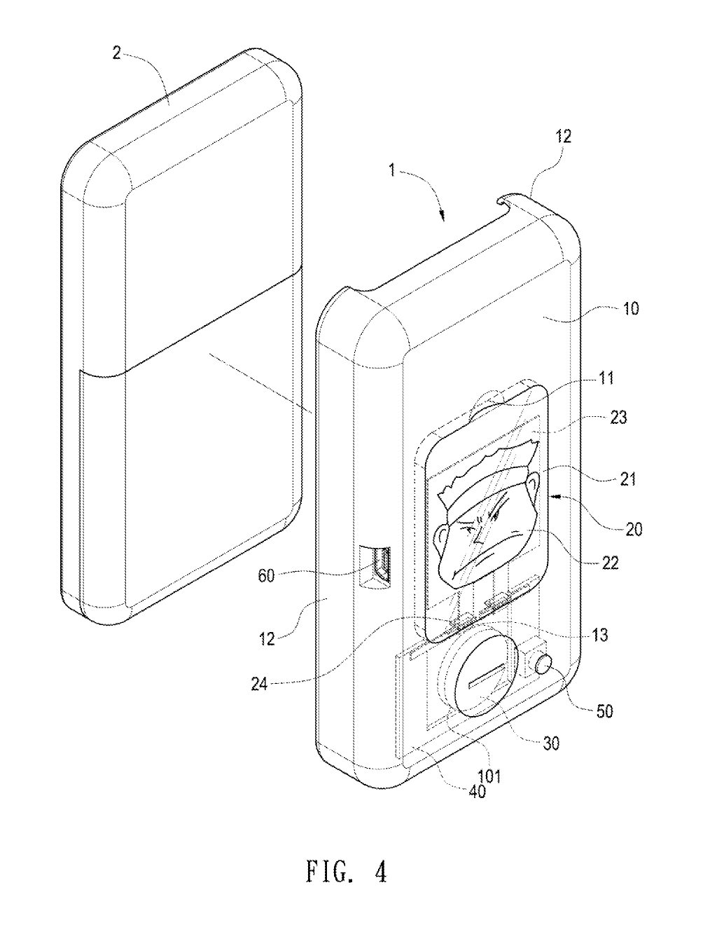

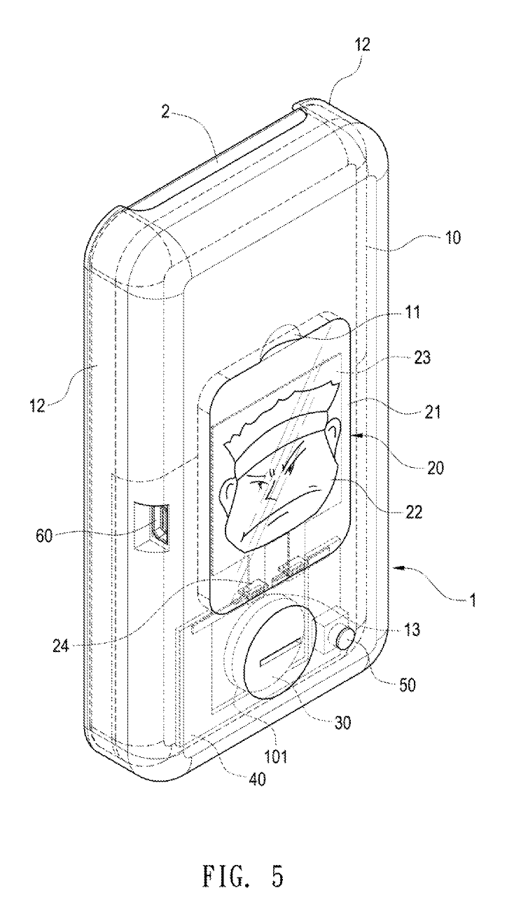

FIGS. 4 and 5 are a schematic assembling view and a schematic view of usage state of the graphic light module 1 assembled with a portable device 2. As seen in FIGS. 4 and 5, the graphic light module 1 is integrated onto the portable device 2, such as the front or back outer casing of a cell phone or a personal digital assistant (PDA) device. In the present embodiment, the attachment part 12 of the case body 10, which is disposed as the attachment prong of a sliding cover, is slidably attached to the back panel of the portable device 2. As such, the graphic light module 1 is secured onto the portable device 2. Activating the switch device 50 would then allow the light emitting component 23 of the graphic light block 20 to produce light, and subsequently the image of the image component 22 would then be shown from light transmission.

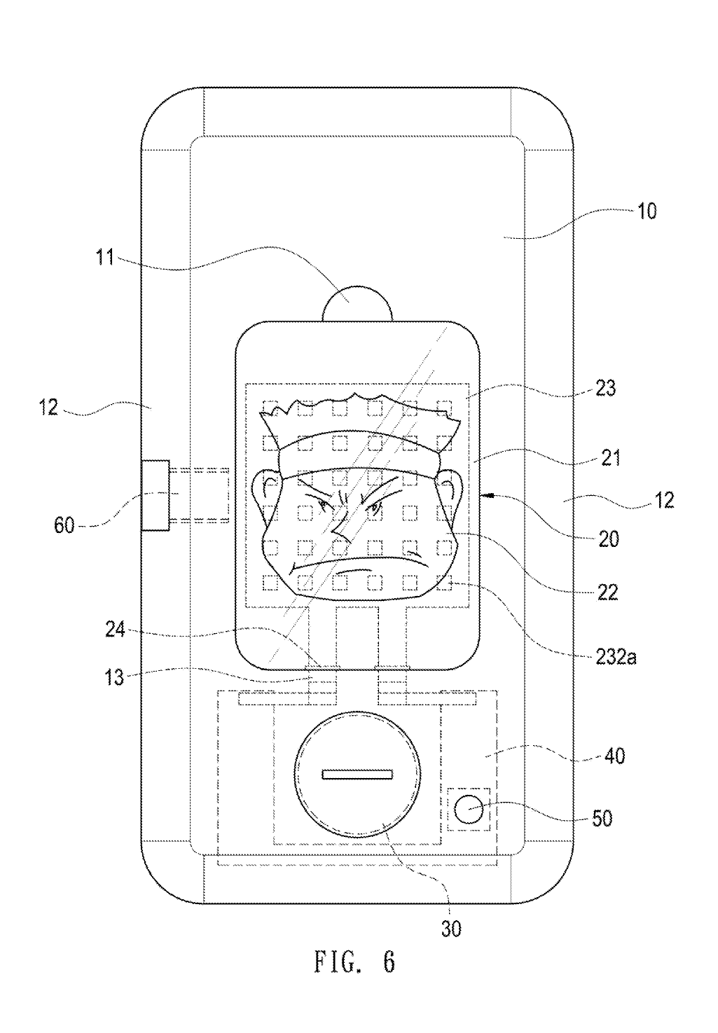

FIG. 6 is another embodiment of the graphic light module. The difference between the present embodiment and the previous embodiment can be seen in that the light emitting component 23a of the graphic light block 20 includes a light emitting circuit board 231a and a plurality of light emitting diodes 232a disposed on the light emitting circuit board 231a. The light emitting circuit board 231a is electrically coupled to the second contact point 24. When the second contact point 24 and the first contact point 13 come in contact with each other, the power supply unit 30 may provide electricity to the plurality of light emitting diodes 232a through the circuit board 40.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A graphic light module for use with a portable device, comprising:
a case body combined with an outer casing of the portable device, the case body being formed with an accommodating space;
a graphic light block replaceably disposed in the accommodating space, the graphic light block comprising a light-permeable film, an image component combined with the light-permeable film, and a light emitting component; and
a power supply unit disposed in the case body and electrically coupled to the light emitting component, wherein the power supply unit supplies power to the light emitting component to allow the light emitting component to emit light to display a graphic image of the image component.

2. The graphic light module of claim 1, further comprising a circuit board and a switch device electrically coupled to the circuit board, wherein the circuit board is electrically coupled to the light emitting component and the switch device controls activation of the light emitting component through the circuit board.

3. The graphic light module of claim 2, wherein the switch device is a multi-way switch.

4. The graphic light module of claim 2, wherein the circuit board is electrically coupled to the power supply unit and the power supply unit supplies power to the light emitting component through the circuit board.

5. The graphic light module of claim 2, wherein the case body has a charging port electrically coupled to the circuit board.

6. The graphic light module of claim 5, wherein a first contact point is disposed near one side of the circuit board within the accommodating space of the case body and is electrically coupled to the circuit board, and a second contact point is disposed on one side of the light-permeable film of the graphic light block adjacent to the circuit board and is electrically coupled to the light emitting component.

7. The graphic light module of claim 1, wherein the case body is an integral part secured on the outer casing of the portable device.

8. The graphic light module of claim 1, wherein the case body has a power source accommodating space, wherein the power source accommodating space accommodates the power supply unit.

9. The graphic light module of claim 1, wherein the light emitting component is a light emitting diode.

10. The graphic light module of claim 1, wherein the light emitting component is a liquid crystal display.

11. The graphic light module of claim 1, wherein the light emitting component is an electroluminescent light.

12. The graphic light module of claim 1, wherein the light emitting component comprises a light emitting circuit board and a plurality of light emitting elements disposed on the light emitting circuit board.

13. The graphic light module of claim 1, wherein the image component is a graphic image sheet.

14. The graphic light module of claim 1, wherein the power supply unit is a one-time use battery, a rechargeable battery, or a solar cell.
